(19) United States
(12) Patent Application Publication
(10) Pub. No.: US 2013/0110618 A1
(43) Pub. Date: May 2, 2013

(54) ONLINE ARTICLE SYNDICATION VIA CONTENT PACKAGES

(71) Applicants: Su-Lin Wu, San Carlos, CA (US); Chris Leggetter, Belmont, CA (US)

(72) Inventors: Su-Lin Wu, San Carlos, CA (US); Chris Leggetter, Belmont, CA (US)

(73) Assignee: Yahoo! Inc., Sunnyvale, CA (US)

(21) Appl. No.: 13/333,875

(22) Filed: Dec. 21, 2011

Related U.S. Application Data
(60) Provisional application No. 61/554,923, filed on Nov. 2, 2011.

(51) Int. Cl. G06Q 30/02

(52) U.S. Cl. 705/14.46; 705/30; 705/14.69; 705/14.66

(57) ABSTRACT

A method for syndicating an electronic publication is provided. A content pool having a plurality of content pieces is defined, and a selection of content pieces of the content pool is received from a curator, the selection of content pieces defining a content package. Then, an electronic publication is defined to present the content package. The electronic publication is transmitted for viewing on a presentation device. Interactions with the electronic publication when presented on the presentation device are tracked. And a revenue amount is determined for the curator based on the tracked interactions with the electronic publication.

### CLAIM OF PRIORITY

This application claims priority to U.S. Provisional Patent Application No. 61/554,923, filed Nov. 2, 2011, entitled “ONLINE ARTICLE SYNDICATION VIA CONTENT PACKAGES,” the disclosure of which is herein incorporated by reference.

### BACKGROUND

1. Field of the Invention

The present invention relates to methods and systems for syndicating an electronic publication.

2. Description of the Related Art

In recent years, tablet computing devices have gained popularity, providing a large touchscreen interface for intuitive input and interaction, and leveraging improvements in wireless connectivity. The increasing prevalence of tablet computing devices has fueled the rise of electronic publications, which are able to deliver rich media experiences to the end user by virtue of the flexible format afforded by tablet computers. However, the creation of such electronic publications has heretofore required large expenditures of resources in order to procure and monetize content across all interested parties.

It is in this context that embodiments of the invention arise.

### SUMMARY

Broadly speaking, embodiments of the present invention provide methods and systems for online article syndication via content packages. Several inventive embodiments of the present invention are described below.

In one embodiment, a method is provided for syndicating an electronic publication. The method initiates with defining a content pool having a plurality of content pieces. The method includes receiving a selection of content pieces of the content pool from a curator, the selection of content pieces defining a content package. Then, an electronic publication is defined to present the content package. The electronic publication is transmitted for viewing on a presentation device. Interactions with the electronic publication when presented on the presentation device are tracked. And a revenue amount is determined for the curator based on the tracked interactions with the electronic publication.

In one embodiment, the operation of defining the electronic publication includes defining a display advertisement location within the electronic publication. The operation of transmitting the electronic publication includes retrieving a display advertisement to be presented at the display advertisement location. And the operation of tracking interactions with the electronic publication includes tracking interactions with the display advertisement.

In one embodiment, the operation of retrieving the display advertisement includes selecting the display advertisement from a display advertisement pool based on one or more of user data of a user to whom the electronic publication is presented or the tracked interactions with the electronic publication.

In one embodiment, the user data includes one or more of age, gender, and geographic location.

In one embodiment, defining the content pool includes receiving the plurality of content pieces from a plurality of authors.

In one embodiment, tracking interactions with the electronic publication includes tracking interactions with a specific content piece included in the electronic publication.

In one embodiment, the method includes determining a revenue amount for a corresponding author of the specific content piece based on the tracked interactions with the specific content piece.

In one embodiment, the method includes determining a rating level of a corresponding author of the specific content piece based on the tracked interactions with the specific content piece.

In one embodiment, the method includes presenting the content pieces of the content pool for selection by the curator.

In one embodiment, presenting the content pieces of the content pool includes providing a search tool for searching the content pieces of the content pool.

In another embodiment, a method for syndicating an electronic publication is provided. The method includes defining an advertorial pool having a plurality of advertorials provided by a plurality of advertisers, and receiving a selection of an advertorial of the advertorial pool from a curator. A content package is defined including the selected advertorial. An electronic publication is defined to present the content package. The electronic publication is transmitted for viewing on a presentation device. Interactions with the selected advertorial when presented on the presentation device as part of the electronic publication are tracked. An amount to be paid by a corresponding advertiser of the selected advertorial is determined based on the tracked interactions. And a revenue amount for the curator is determined based on the tracked interactions.

In one embodiment, the selected advertorial defines a target audience and an associated monetization value for presentation of the selected advertorial to the target audience. Tracking interactions with the selected advertorial includes determining whether the selected advertorial is presented to its defined target audience. And determining the amount to be paid by the corresponding advertiser of the selected advertorial is based on the selected advertorial's associated monetization value and whether the selected advertorial is presented to its defined target audience.

In one embodiment, the selected advertorial defines a cost-per-click for an item in the selected advertorial. Tracking interactions with the selected advertorial includes determining whether the item in the selected advertorial is clicked on. And determining the amount to be paid by the corresponding advertiser of the selected advertorial is based on whether the item in the selected advertorial is clicked on and the cost-per-click.

In one embodiment, the selected advertorial defines a cost-per-conversion. Tracking interactions with the selected advertorial includes determining whether a conversion has occurred via the selected advertorial. And determining the amount to be paid by the corresponding advertiser of the selected advertorial is based on whether a conversion has occurred via the selected advertorial and the cost-per-conversion.

In one embodiment, the content package includes a non-advertorial content piece.

In one embodiment, determining a revenue amount for an author of the non-advertorial content piece based on the tracked interactions.

In one embodiment, the method includes reporting the tracked interactions to the corresponding advertiser.

In another embodiment, a method for determining revenue of an advertorial in an electronic publication is provided. The method includes defining an electronic publication to include an advertorial, and transmitting the electronic publication for viewing by a reader on a presentation device. Interactions with the advertorial when presented on the presentation device as part of the electronic publication are detected. An engagement value for the reader is determined based on the detected interactions. The transmitting, the detecting of the interactions, and the determining of the engagement value are repeated for a plurality of readers. An amount to be paid by a corresponding advertiser of the advertorial is determined based on the engagement values of the plurality of readers.

In one embodiment, the interactions include one or more of the following: time spent on the advertorial, time spent on a page of the advertorial, selection of a link in the advertorial, a zoom interaction, a resize interaction, a scroll, a refresh, an amount of an audio stream consumed, an amount of a video stream consumed.

In one embodiment, the method includes determining a reader value for each of the plurality of readers, the reader value indicating similarity of the reader to a target demographic of the advertorial. And determining the amount to be paid by the corresponding advertiser of the advertorial is based on the reader values of the plurality of readers.

In one embodiment, the target demographic is defined by one or more of age, gender, and geographic location.

In one embodiment, determining the reader value includes retrieving reader data of each of the plurality of readers and comparing the retrieved reader data to the target demographic of the advertorial.

In one embodiment, the reader value is a binary quantity.

In one embodiment, determining the amount to be paid by the corresponding advertiser of the advertorial includes determining an overall value for each of the plurality of readers based on the reader's engagement value and reader value.

In one embodiment, determining the engagement value is based on a mapping of combinations of interactions to predefined engagement values.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings in which:

FIG. 1 illustrates an overview of a system for syndicating an electronic publication, in accordance with an embodiment of the invention.

FIG. 2 illustrates tracking of interactive activity with an electronic publication, in accordance with an embodiment of the invention.

FIG. 3 illustrates revenue generation and distribution in a system for syndicating electronic publications, in accordance with an embodiment of the invention.

FIG. 4 illustrates an author's submission of a content piece to a content pool, in accordance with an embodiment of the invention.

FIG. 5 illustrates a curator's submission of a content package to a content package library, in accordance with an embodiment of the invention.

FIG. 6 illustrates tracking of interactions with display advertising and advertorials in an electronic publication, in accordance with an embodiment of the invention.

FIG. 7 illustrates selection of an advertorial for a designated location in an electronic publication, in accordance with an embodiment of the invention.

FIG. 8 illustrates ratings of authors of content pieces, in accordance with an embodiment of the invention.

FIG. 9 illustrates a method for determining a price to be paid by an advertiser for an advertorial based on tracked engagement of readers, in accordance with an embodiment of the invention.

FIG. 10 illustrates a category view of an online publication stand rendered on a tablet computer, in accordance with an embodiment of the invention.

FIG. 11 illustrates a user's library view of an online publication stand, in accordance with an embodiment of the invention.

FIG. 12 illustrates a view of a page from an electronic publication, in accordance with an embodiment of the invention.

### DETAILED DESCRIPTION

The following embodiments describe systems and methods for syndicating an electronic publication. According to embodiments of the invention, the electronic publication is defined to present a content package which contains a selection of various content pieces. Authors submit content pieces to a content pool, and curators select content pieces from the content pool to define a content package. Additionally, advertisers can provide advertorials which are submitted to an advertorial pool and which may be selected for inclusion in a content package by a given curator. Advertisers may also provide display advertising that is presented alongside the content pieces of a given electronic publication. The systems and methods of the present invention provide mechanisms whereby both authors and curators are rewarded for their provision of content and selection of content, respectively.

It will be obvious, however, to one skilled in the art, that the present invention may be practiced without some or all of these specific details. In other instances, well known process operations have not been described in detail in order not to unnecessarily obscure the present invention.

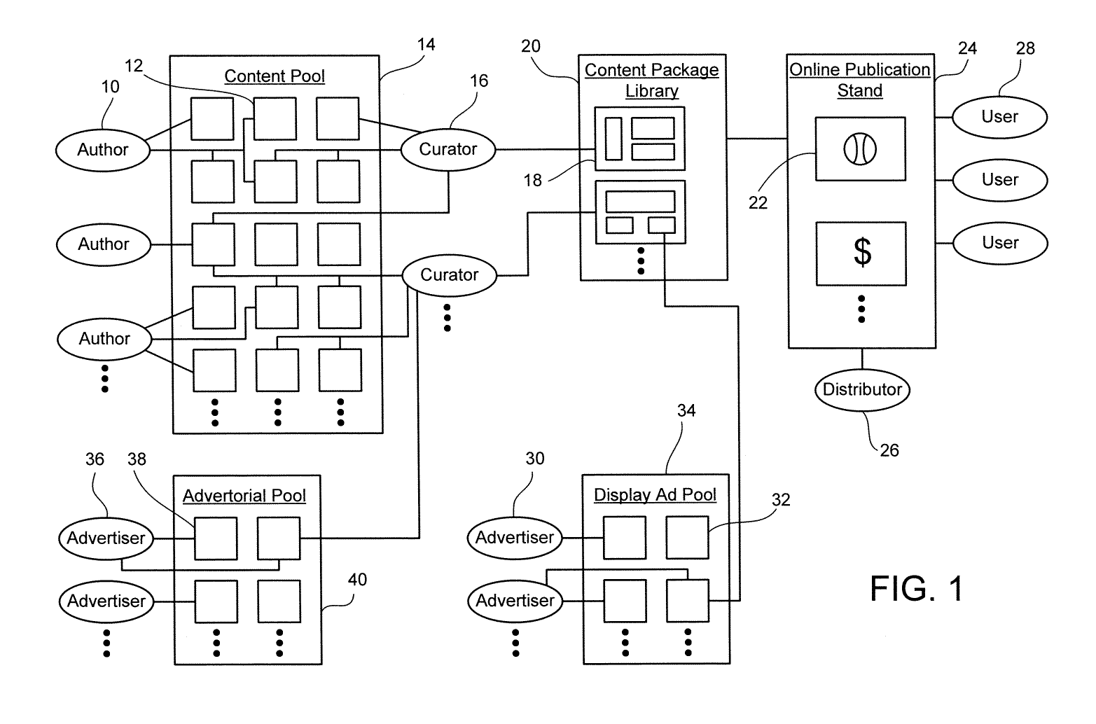

FIG. 1 illustrates an overview of a system for syndicating an electronic publication, in accordance with an embodiment of the invention. As shown, various authors 10 generate content pieces 12 that are stored as part of a content pool 14. The content pieces 12 can be any kind of content that may be included as part of an electronic publication, such as articles, images, audio, video, and other kinds of content.

A curator 16 selects various content pieces from the content pool 14 for inclusion in a content package 18. Thus, each content package is defined by the curators particular taste in selecting content pieces for the content package. Additionally, the content package 18 can include curator generated content such as editorial pieces. As various curators produce a plurality of content packages, the content packages are stored in a content package library 20.

The content package 18 is presented via an electronic publication 22. Electronic publication 22 is made available via an online publication stand 24 that is operated by a distributor 26. Various users 28 access the online publication stand 24 through a computing device such as a tablet computer and retrieve electronic publication of their choice for viewing on their computing device. For purposes of the present disclosure, an electronic publication will be broadly understood as an electronic or digital analogue to a print publication such as a magazine, periodical, newspaper, newsletter, or the like. Thus, an electronic publication will generally contain a plurality of pages upon which a fixed selection of content is presented. The plurality of pages will have a specified ordering, and the electronic publication may include a cover page and a table of contents. Electronic publication is to be distinguished from other types of electronic content presentation vehicles such as a webpage or website.

Various advertisers 30 generate display ads 32 which are stored in a display ad pool 34. At the time an electronic publication is transmitted to a user, various display ads are selected from the display ad pool 34 for incorporation into the electronic publication alongside the content pieces defined in the content package to be presented in the electronic publication. The display ads incorporated into a given electronic publication can be dynamically chosen based on various factors such as attributes of the particular user to whom the electronic publication will be sent and dynamically detected interactions with the electronic publication.

Additionally, an advertiser 26 can generate an advertorial 38 which is stored as part of an advertorial pool 40. A curator can select an advertorial from the advertorial pool for inclusion in a particular content package. An advertorial will be generally understood as an advertisement that takes the form of an editorial. Unlike regular advertisements, and advertorial is generally designed to look like the articles which appear in a given publication, and typically contains a proportionately large amount of informative content that is not a direct offer of the service or product for sale. Because publishers do not want readers to be confused about the source of the content which they are reading, advertorials generally include an indicator that they are in fact advertisements, such as by the placement of terms like “ADVERTISEMENT,” “PAID ADVERTISEMENT,” “SPECIAL PROMOTIONAL FEATURE,” “SPECIAL ADVERTISING SECTION,” etc. in the advertorial.

As described in further detail below, the presently described system facilitates sharing of revenue to both authors and curators. Briefly stated, advertisers pay based on the presentation and or interaction with display advertisements and advertorials in the electronic publications. The authors and curators receive a share of this revenue based on the popularity of their respective content pieces and content packages.

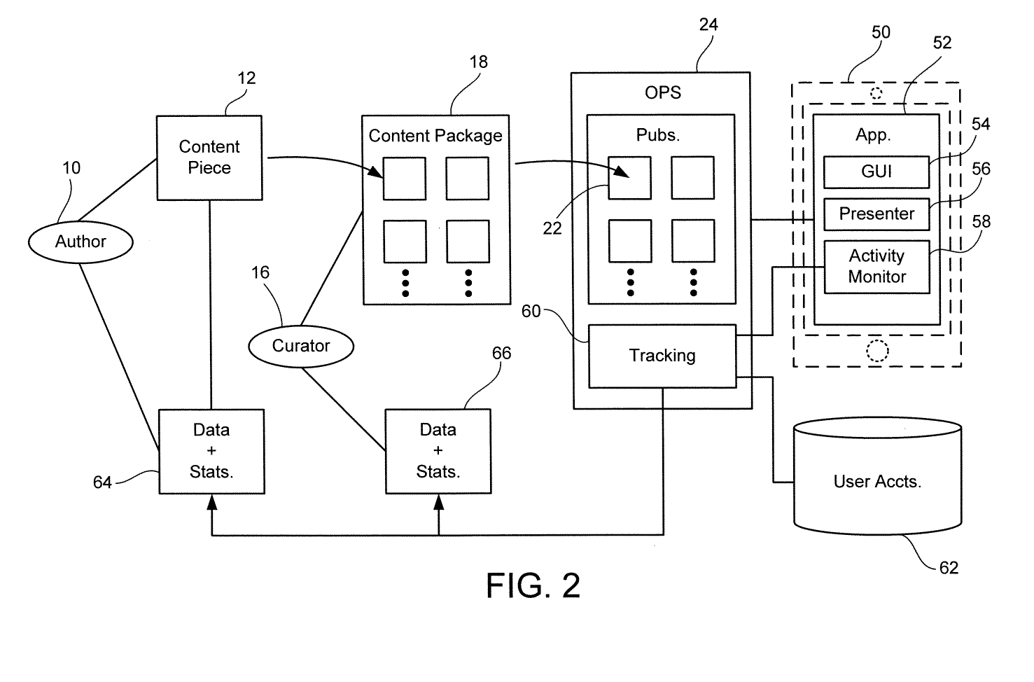

FIG. 2 illustrates tracking of interactive activity with an electronic publication, in accordance with an embodiment of the invention. As shown, the author 10 prepares a content piece 12 that is selected by a curator 16 for inclusion in a content package 18. The content package 18 is presented in an electronic publication 22 to a user. In the illustrated embodiment, the user accesses the online publication stand 24 via a presentation device 50. In one embodiment, the presentation device 50 is a tablet computer. However, in other embodiments, the presentation device 50 can be any of various kinds of devices facilitating display of and interactivity with an electronic publication, such as mobile phones, laptop computers, desktop computers, wireless devices, and the like.

The presentation device 50 runs an application 52 which facilitates access to the online publication stand 24. The application 52 includes a graphical user interface 54 for enabling the user to navigate the online publication stand 24 and select a particular electronic publication for viewing. A presenter 56 renders a selected electronic publication on the presentation device 50. The application 52 additionally includes an activity monitor 58 which detects interactions with the selected electronic publication as it is presented on the presentation device 50. The interactions with the electronic publication can include any of various types of detectable indicators of user engagement with the electronic publication, such as the number of pages viewed in a multi-page article, the time spent on a given page, time spent on a particular article or advertorial, clicks or taps on various links, zooming, resizing, scrolling, refreshing, a percentage of an audio or video media stream consumed, and others.

The interaction data detected by the activity monitor is communicated to a tracking module 60 of the online publication stand 24, that processes the interaction data and associates it with various entities to enable later analysis and revenue determination. In one embodiment, the interaction data is processed and associated with the user's account in a user accounts storage 62. In this manner, a user's history of interactions with various publications can be analyzed to facilitate publication recommendations to the user as well as better targeting of advertising within publications which the user reads.

In one embodiment, interaction data relevant to the particular content piece 12 is processed and associated with the content piece 12 as part of a data and statistics module 64. The data and statistics module 64 then makes this data available to the author 10, so that the author can view the performance of his or her content piece 12. By aggregating data across all publications in which the content piece 12 appears, it is possible to determine the number of times the content piece 12 has been read and characterize the interactions with the content piece 12 which are occurring amongst readers who view the content piece.

Additionally, user account data can be incorporated into the data and statistics module 64 to enable analysis of demographic information for the content piece 12. For example, the data and statistics module can determine statistics relating to the age, gender, location, income, subscription preferences or any other demographic information available in user accounts as applied to the specific content piece 12. Merely by way of example, statistics for the content piece may include the average age of readers, an age distribution of readers, percentage of readers of each gender, a geographic distribution of readers, income level distribution of readers, etc.

Also, it is possible to provide more nuanced analysis of interactions as a function of demographic data. For example, the data and statistics module 64 may be configured to determine the average amount of time spent on the content piece by readers of different age groups, gender, locations, etc. Similarly, any other tracked interaction can be related to any kind of demographic information for which data are available. In this manner, authors are able to better understand the readership of their content pieces, and may tailor their content pieces so as to reach specific audiences if so desired.

In a similar manner as described with reference to the content piece 12, interaction data resulting from interactions with the electronic publication 22 which are relevant to the content package 18 presented in the electronic publication can be processed by the tracking module 60 and associated with the content package 18 in a data and statistics module 66. The data and statistics module 66 can be configured to provide the curator with information and analysis about readers' interactions with the curator's content package and demographic information about the readers themselves. For example, the data and statistics module 66 can provide interaction information such as the number of readers accessing the content package in an electronic publication during a specified time period, the average amount of time spent reading the content package, the average amount of time spent on a given content piece within the content package, the average number of pages viewed, the number of readers viewing the content package at different times of day, etc. Additionally, demographic information can be analyzed and provided, so as to enable the curator to understand characteristics of their readership. Examples of demographic statistics include the age, gender, location, and income level of readers of the content package. By enabling curators to understand the interactions and demographics of their readership, they can more effectively tailor their content packages to reach specific audiences.

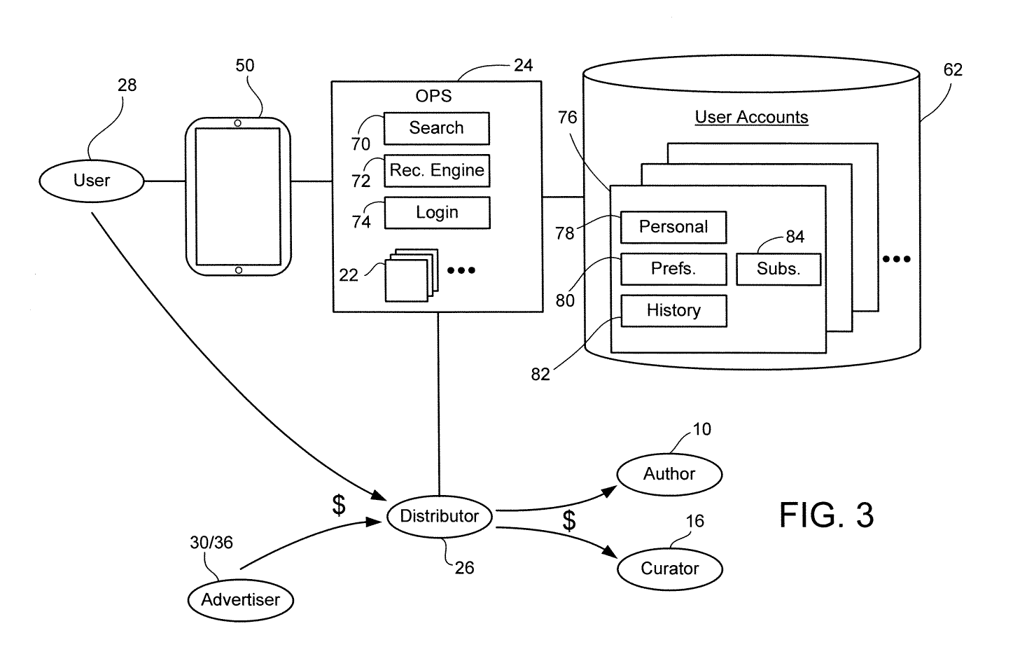

FIG. 3 illustrates revenue generation and distribution in a system for syndicating electronic publications, in accordance with an embodiment of the invention. As shown, a user 28 accesses an online publication stand 24 via a presentation device 50. As has been previously described, the online publication stand 24 makes various electronic publications 22 available to the user 28 for viewing. The online publication stand includes a search module 74 enabling the user 28 to search the various electronic publications 22. The user accounts storage 62 stores various user accounts 76. In one embodiment, a user account can include personal information 78 which includes personal information such as a user's name, age, gender, date of birth, residence, income, as well as various other types of information.

The user account may additionally include preferences 80 which consist of preferences in content which have been indicated by the user. For example, a user may indicate that he or she is interested in certain categories of content, wishes to receive e-mail notifications about new editions of publications they subscribe to, etc. Also, the user's account may include subscriptions 84 that indicate the electronic publications to which the user has subscribed. The user's account may also contain the user's interactive history 82, which provides a record of the user's interactions with various electronic publications. Such historical data can be utilized for various purposes to improve the user's experience in utilizing the online publication stand 24.

For example, advertisements or advertorials included in a given electronic publication can be selected in part based on the user's prior interactive history so as to provide advertisements and advertorials which are more likely to interest the user and so generate revenue. Also, the user's interactive history with an electronic publication can be utilized to recall the user's last viewed page of the electronic publication so that the user may continue reading the electronic publication from where he or she left off. A user's interactive history can also be analyzed to determine which portions of various electronic publications the user reads, and so develop a profile of the user's taste and interests.

In one embodiment, the online publication stand 24 includes a recommendation engine 72 which provides recommendations regarding electronic publications for a given user based on the information in the user's account. Thus, the recommendations can be based on the user's personal information, indicated preferences, current subscriptions, and/or interactive history. The online publication stand 24 additionally includes a login module which authenticates users to the online publication stand 24, to permit access to the user's account and the electronic publications.

Also shown with continued reference to FIG. 3 is a flow of revenue amongst users 28, advertisers 30 or 36, distributor 26, authors 10, and curators 16. Users 28 may pay subscription fees to the distributor 26 in order to subscribe to certain electronic publications offered in the online publication stand 24. Advertisers 30, who offer display ads which are presented in certain electronic publications, pay the distributor 26 based on the display ads' performance, such as on a cost-per-impression, cost-per-click, or cost-per-conversion basis. Also, advertisers 36 who provide advertorials for inclusion in electronic publications pay the distributor 26 based on the performance of their advertorials and whether of not the advertorials reached their target audience. The distributor retains a portion of the revenues received from the users 28, and the advertisers 30 and 36, and distributes portions of the revenues to the authors 10 and the curators 16. The authors 10 may receive revenue based on the performance of their submitted content pieces, such as the number of times their content pieces were presented in an electronic publication. Similarly, the curators 16 may receive revenue based on the performance of their content packages as presented in electronic publications, as indicated by such measures as the number of subscribers to the electronic publication, the number of views of the content package, the percentage of their content package viewed, the performance of display advertising appearing in the electronic publication in which their content package is presented, the performance of advertorials in their content package, etc.

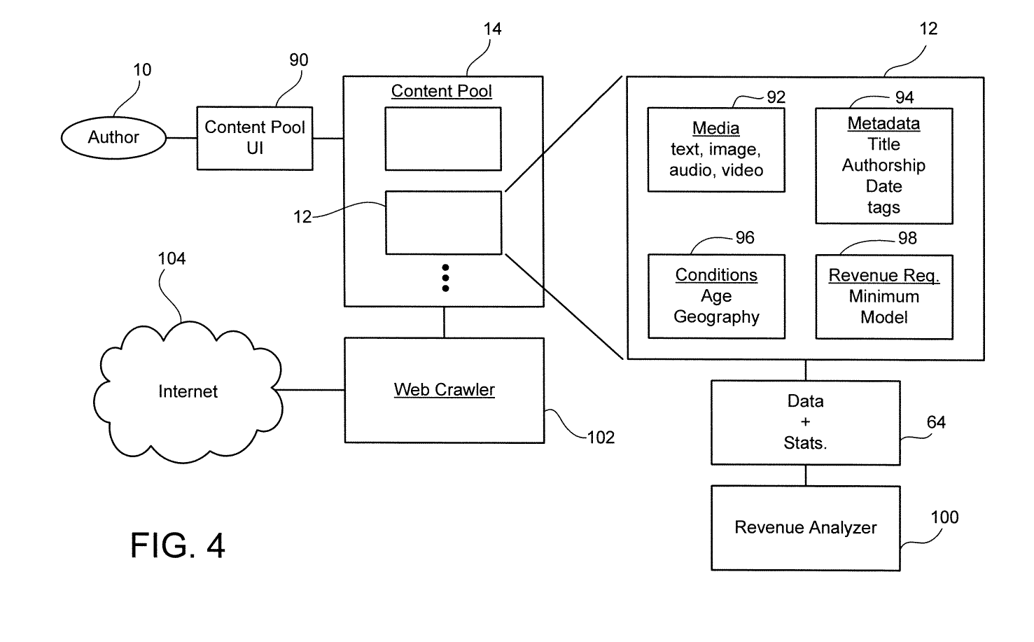

FIG. 4 illustrates an author's submission of a content piece to a content pool, in accordance with an embodiment of the invention. As shown, the author 10 utilizes a content pool user interface 90 in order to submit a content piece 12 into the content pool 14. In one embodiment, the user interface 90 may be a web-based interface that is accessed through a web browser, whereas in another embodiment, the user interface 90 is a standalone application. The content piece 12 may include media 92 such as text, images, audio, or video. Additionally, the content piece 12 can include various kinds of metadata, such as a title, authorship, and the date the content piece was created or last updated. Additionally, the metadata 12 can include tag words which relate to the contents of the media 92. Tag words are useful for enabling keyword searches of the content pieces in the content pool 14.

Also, the author 10 can set conditions 96 on their content piece 12, such as geographic or age-based restrictions. And the author 10 can define revenue requirements 98 for the use of the content piece 12. For example, the revenue requirements 98 may include a minimum revenue amount for the use of the content piece 12 in a content package. Or the revenue requirements 98 could define a particular revenue sharing model for the content piece, such as based on number of views, page views, or a flat fee for use in a content package and subsequent electronic publication.

As has been described, a data and statistics module 64 includes interaction data and statistics relating to the content piece 12. A revenue analyzer 100 determines the revenue amount for the content piece 12 based on its interaction data and any revenue requirements 98 defined for the content piece 12.

In one embodiment, a web crawler 102 accesses the Internet 104 and automatically adds content pieces to the content pool 14 from sources available over the Internet.

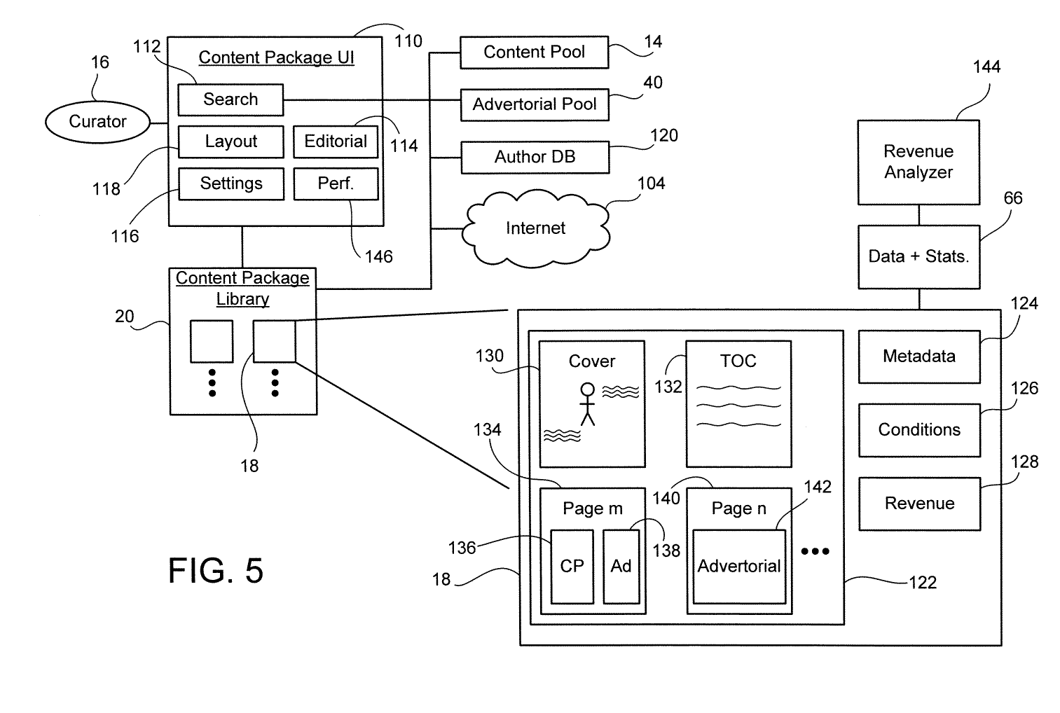

FIG. 5 illustrates a curator's submission of a content package to a content package library, in accordance with an embodiment of the invention. As shown, a curator 16 accesses a content package user interface 110 which provides tools for enabling the curator 16 to create and manage a content package 18 in the content package library 20. The user interface 110 includes a search tool 112 which enables the curator 16 to search for content to place in the content package 18. The search tool 112 facilitates searches for content pieces within the content pool 14 as well as advertorials within the advertorial pool 40. Additionally, the search tool 112 may facilitate searching in an author database 120, which enables the curator 16 to search for specific authors or according to characteristics of the authors as defined in the authors database 120. The author database is described in further detail below. Additionally, in one embodiment, the search tool 112 facilitates searches for content over the Internet 104.

In various embodiments, the search tool 112 may be configurable by the curator 16 to provide search filtering based on any known metadata or other characteristics of the content. For example, with reference to the aforementioned content pieces, the search tool 112 can be configured to search according to media type (e.g. text, image, audio, video), metadata such as keyword tags, title, date, and authorship, conditions such as age or geographic restrictions, revenue requirements such as minimum revenue and revenue model requirements. The search tool may also enable filtering based on interaction data or performance data associated with the content pieces. Similar search functionality may be applied to the aforementioned advertorials, for example facilitating searches for advertorials based on, and/or filtered according to, keywords, metadata, advertiser identity, revenue requirements, etc.

An editorial tool 114 is provided for enabling the curator 16 to generate their own original content to include in the content package 18. For example, the curator 16 may utilize the editorial tool 16 to generate editorials, a cover page 130, a table of contents page 132, etc. A settings tool 116 is provided for enabling the curator 16 to define various settings for the content package 18, such as defining metadata, 124, conditions 126, or revenue requirements 128. In one embodiment, the revenue requirements 128 define one or more monetization methods for the content package, such as subscription fees, display advertising, or advertorials. In one embodiment, the curator can choose between a subscription-based monetization method and an advertising-based monetization method. In the case of advertising-based monetization, then the system is configured to present the content package with display advertising, whereas in the case of subscription-based monetization, the system is configured to present the content package without any advertising.

In one embodiment, the content package defines a selection of content pieces and the system is configured to automatically determine the layout of those content pieces in the electronic publication. The specific layout for a given electronic publication may vary for different readers according to their preferences and characteristics. Further, display advertising, if chosen as a monetization method, can be automatically selected and arranged in the pages of the electronic publication.

In another embodiment, the user interface 110 includes a layout tool 118 to enable the curator 16 to design their own layout for the content package 18. For example, the curator 16 can design the placement of a content piece 136 on a page 134, and designate a region 138 on the page for a display advertisement. The curator 16 could also indicate the placement of an advertorial 142 on a page 140.

As has been described, a data and statistics module 66 stores and analyzes interaction data of the content package 18. A revenue analyzer 144 is also provided for analyzing the interaction data of the content package and determining the revenue amount for the curator 16 based on the content package's performance. A performance tool 146 is provided as part of the user interface 110 to enable the curator 16 to access the performance of their content package. For example, the curator is able to view what content pieces are being read, how any advertising is performing, what demographics are reading the content package or a specific content piece, etc. Based on this information, the curator is enabled to fine tune the content selection and advertising selection for their readership.

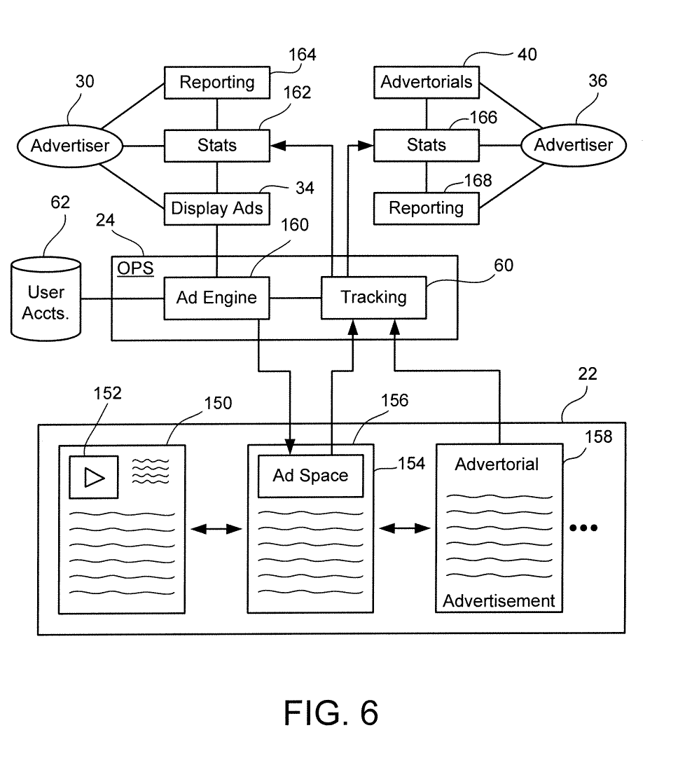

FIG. 6 illustrates tracking of interactions with display advertising and advertorials in an electronic publication, in accordance with an embodiment of the invention. As shown, the electronic publication 22 is defined by various pages including pages 150, 154, and 158. Page 150 includes an embedded video presentation 152. Page 154 includes content of a content piece as well as a designated region 156 for display advertising. At the time of rendering of the electronic publication 22, the region 156 is populated with a display advertisement chosen from the display ad pool 34 by an ad engine 160. The ad engine 160 may choose the specific advertisement from the ad pool 34 based on characteristics of the user as defined in user accounts 62, as well as tracked interactions of the user with the electronic publication 22 itself, as tracked by tracking module 60. Characteristics of the user can include age, gender, geo-location, historical behavior, etc. The tracking module 60 also tracks interactions with the display advertisement shown at region 156, and reports these interactions to a data and statistics module 162. A reporting module 164 enables the advertiser 30 to view the data and statistics pertaining to their advertisement, and so assess their advertisement's performance.

The tracking module 60 also tracks the interactions with the advertorial shown on the page 158 of the electronic publication 22. These interactions are reported to a data and statistics module 166. The advertiser 36 is able to review the performance of the advertorial via a reporting module 168.

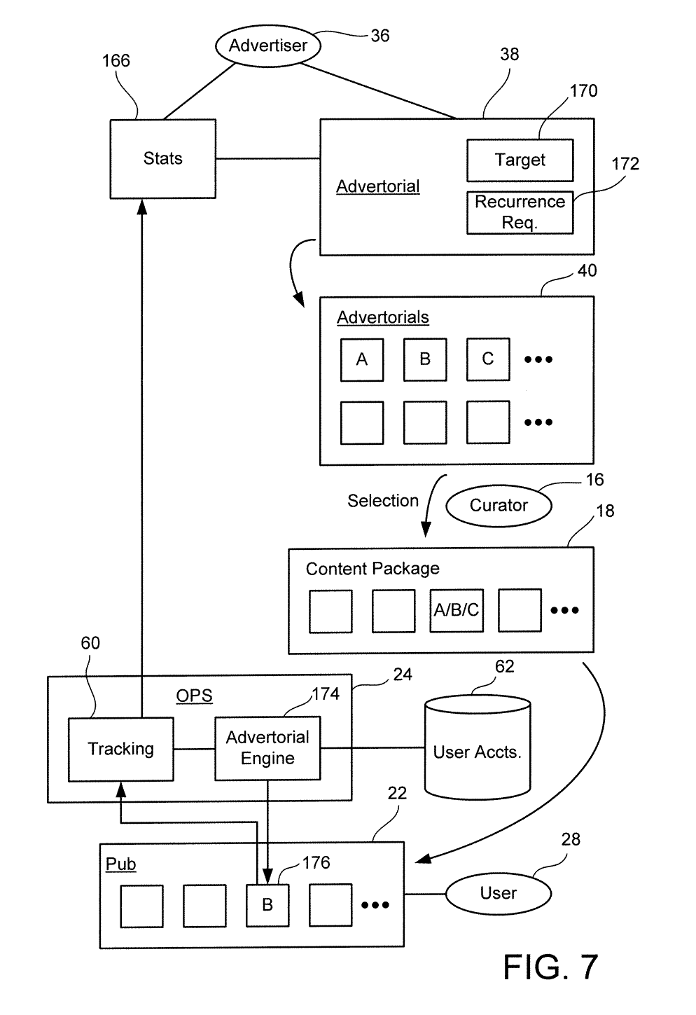

FIG. 7 illustrates selection of an advertorial for a designated location in an electronic publication, in accordance with an embodiment of the invention. As shown, an advertiser 36 submits an advertorial 38 to an advertorial pool 40. The advertorial 38 also defines a target audience 170 which specifies demographic characteristics of a specific readership for whom the advertiser is willing to pay when the advertorial 38 is presented to them. The advertorial 38 may also include revenue requirements 172 which define any requirements regarding revenue flowing from the advertorial, such as an overall limit on revenue from the advertorial, limits per electronic publication, or specific revenue bids which are tied to particular events such as certain interactions with the advertorial or a conversion flowing from the advertorial.

In the illustrated embodiment, the curator selects advertorials from the advertorial pool 40 for inclusion in the content package 18. More specifically, the curator 16 has specified that the content package will include one advertorial from among advertorials A, B, and C. At the time the electronic publication is defined, transmitted, or rendered, an advertorial engine 174 selects which of the advertorials A, B, or C is to be included in the electronic publication. This selection can be based on the target audience and revenue requirements of the advertorials A, B, and C, as well as characteristics of the user 28 as defined in user accounts 62, and tracked interactions with the electronic publication 22, so as to maximize revenue generation from the advertorial. As shown, the advertorial engine 174 has selected advertorial B for inclusion at location 176 within the electronic publication 22.

Interactions with the advertorial presented in the electronic publication 22 are tracked by a tracking module 60, which reports the interactions to a data and statistics module 166. These data are made available to the advertiser 36 so that they may track the performance of their advertorial.

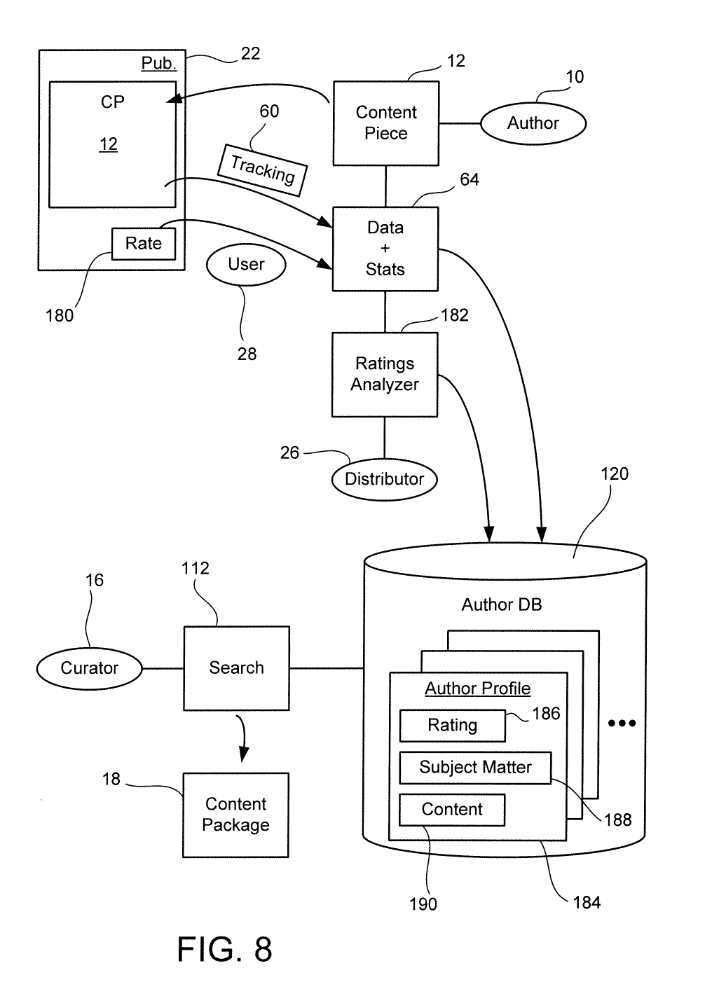

FIG. 8 illustrates ratings of authors of content pieces, in accordance with an embodiment of the invention. The author 10 generates a content piece 12 that is presented in an electronic publication 22. The interactions with the content piece 12 and those related to the content piece 12 (e.g. interactions with display advertising shown alongside the content piece) are tracked by a tracking module 60, and stored in a data and statistics module 64. In one embodiment, the user 28 is given an option to rate the content piece 12, via a ratings interface 180 presented with the content piece in the electronic publication, and provides additional ratings data to the data and statistics module 64.

A ratings analyzer 182 analyzes the performance and ratings data relating to the content piece 12 and generates a rating 186 for the author 10 that is stored as part of the author's profile 184 in the author database 120. In one embodiment, the ratings analyzer 182 generates the author rating 186 automatically. Whereas in another embodiment, the ratings analyzer 182 provides relevant data and analysis for determination of the author's rating, and the distributor 26 determines a final rating for the author. A given author's rating may be based on several factors, such as the number of reads of the author's content pieces, the number of publications in which the author's content pieces appear, user ratings of the author's content pieces, the performance of advertising shown with the author's content pieces, personal data such as age and qualifications, etc. In one embodiment, the rating system may employ a tiered scale, wherein authors are qualified as “platinum,” “gold,” “silver,” “bronze,” or unrated, wherein platinum represents the highest quality of writing and reputation followed by gold, silver, and bronze in descending order. In other embodiments, ratings may come from users or professional editors hired by the distributor. For example, professional editors may determine or approve the qualification of authors on a tiered scale. Furthermore, in other embodiments of the invention, ratings may be applied to content and/or advertorials and made available for review and search functionality by authors and advertisers, as well as publishers.

Additionally, the author profile may include subject matter 188 which identifies the subject matter about which the author is qualified. These may include keywords relating to their areas of expertise so as to facilitate searches. Further, the author's profile 184 provides a listing of content 190 which the author has contributed to the content pool. A curator 16 uses a search engine 112 to search the author database 120 for authors relating to a desired subject. In this manner, the curator 16 is able to find qualified authors in order to obtain trusted content for their content package 18.

The presently described platform enables publishers to easily syndicate electronic publications for presentation on devices such as tablet computers, without having to invest in the technology to produce applications. Furthermore, a single piece of content can be valuable for different audiences and can be repackaged in multiple content packages to reach a much larger audience than would be possible if the content piece were confined to a single publication. The monetization of content pieces and content packages means that authors are rewarded for content creation and curators are rewarded for content selection. Advertisers are also able to reach relevant audiences with their display advertising and advertorials.

The presently described platform also enables advertorials to be targeted and monetized in new ways. In traditional print media, an advertorial may be included in a magazine based on a negotiated price for inclusion that is set up front. However, in the digital content packages described herein, much more detailed analysis can be leveraged to provide pricing models which are tailored to how much value the advertorial generates for both the advertiser and the publisher. For example, if readers positively engage with an advertorial, then the advertiser is receiving value and should pay more, whereas if readers do not engage with the advertorial, then the advertiser is not receiving value and should pay less. By coupling the value proposition for advertisers to the price paid for advertorial presentation, publishers are incentivized to connect advertorial content with a high value audience. Several pricing models for advertorial presentation in electronic publications are now described in detail.

In one embodiment, a basic subscription-based model provides that the advertiser pays based on the estimated number of readers as represented by the number of subscribers of a particular electronic publication in which the electronic publication is presented. Thus, if the electronic publication has N subscribers, then the price for the advertiser P=N*V, where V is the value the advertiser ascribes to each reader. In another embodiment, the number of readers, N_{R}, who actually view the advertorial is tracked. In such a model, then P=N_{R}*V, where V is the value the advertiser ascribes to each reader.

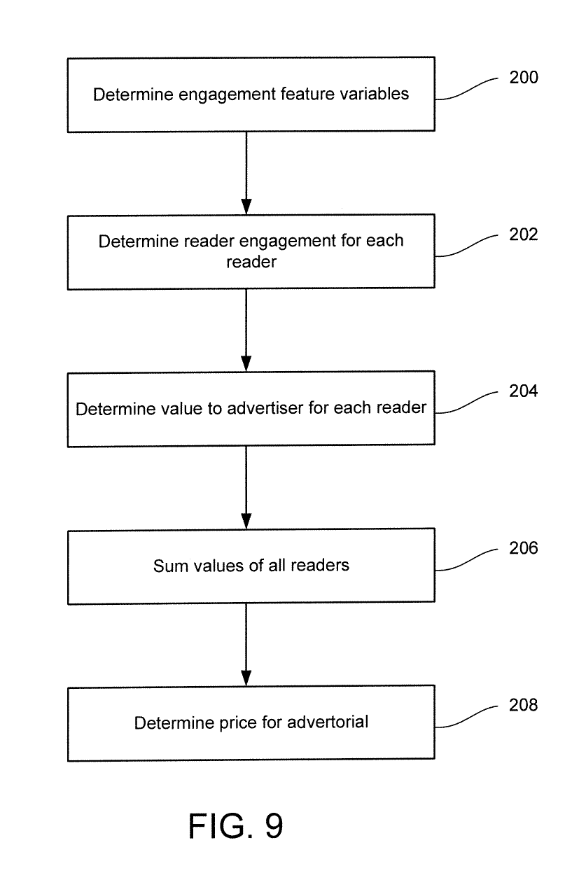

In another embodiment, the pricing model can be based on tracked engagement of the reader. FIG. 9 illustrates a method for determining a price to be paid by an advertiser for an advertorial based on tracked engagement of readers. At method operation 200, a set of engagement feature variables (e₁, e₂, . . . e_{N}) is determined, each having a value range that may be discrete or continuous. Examples of engagement feature variables include the following: time spent on a page, time spent on the entire article, number of page views (for a multi-page article), number of clicks on various links, number of interactions with each page (zoom, resize, scroll, refresh, etc.), percentage of media streams (audio/video) consumed, or combinations of features mapped to an aggregate measurement of engagement features having a scale such as high, medium, low, and none. Then at method operation 202, for each reader, the reader's engagement is calculated as Eᵣ=(e₁, e₂, . . . e_{N}). If a reader reads the advertorial multiple times, then there may be a separate Eᵣ per read, or an aggregate Eᵣ over all instances of reading the advertorial. At operation 204, for each Eᵣ, a value to the advertiser is calculated as Vᵣ=ƒ(Eᵣ). Then at operation 206, the values of all Vᵣ are summed to yield a total reading value of the advertorial T=sum(Vᵣ). At operation 208, then the price of the advertorial is set as a function of T: Price=g(T), where g is agreed between the publisher and the advertiser. In various embodiments, the function g can be a percentage of value, a sliding scale, a tiered scale, define a minimum or maximum cap, etc. It will be noted that in one embodiment, the aforementioned function ƒ can be set manually. For example, the function ƒ could define 0.05 cents per video view, or 0.01 cents if a reader read 4 pages and clicked on a link and bought something, etc. In another embodiment, the function ƒ could be determined by applying machine learning to value each engagement vector Eᵣ.

In another embodiment, a reader value component can be added to the pricing model to account for the value that the advertiser ascribes to the readers' demographics. For example, for a given reader R, a set of reader features can be defined as Rᵣ=(r₁, r₂, . . . rₘ). Then the value per reader can be determined as Vᵣ=ƒ(Eᵣ, Rᵣ). In a simple scenario, the inclusion of reader attributes in the function ƒ modifies the function in a binary manner, such that ƒ(Eᵣ, Rᵣ)=ƒ(Eᵣ) if the reader is in the target demographic defined for the advertorial, whereas ƒ(Eᵣ, Rᵣ)=0 if the reader is not in the target demographic. In this manner, the advertiser only pays for positive engagement from those readers matching the desired target demographic. In other embodiments, the function ƒ(Eᵣ, Rᵣ) assigns each advertorial reader a value based on the combination of amount of engagement and the value of the reader.

It will be noted that mapping of Vᵣ=ƒ(Eᵣ, Rᵣ) can be generated for all values of Eᵣ and Rᵣ by applying machine learning to a set of samples of V, E and R. In one embodiment, an example set of V, E, and R could be generated by selecting a set of readers who have completed a transaction after viewing the advertorial, and using the V as the value of the transaction, along with the corresponding E and R vectors. In another embodiment, the example set of V, E, and R could be generated by selecting a set of readers who have viewed the advertorial, along with the corresponding E and R vectors, and surveying them to assess the likelihood of a transaction, and associating a value with each transaction.

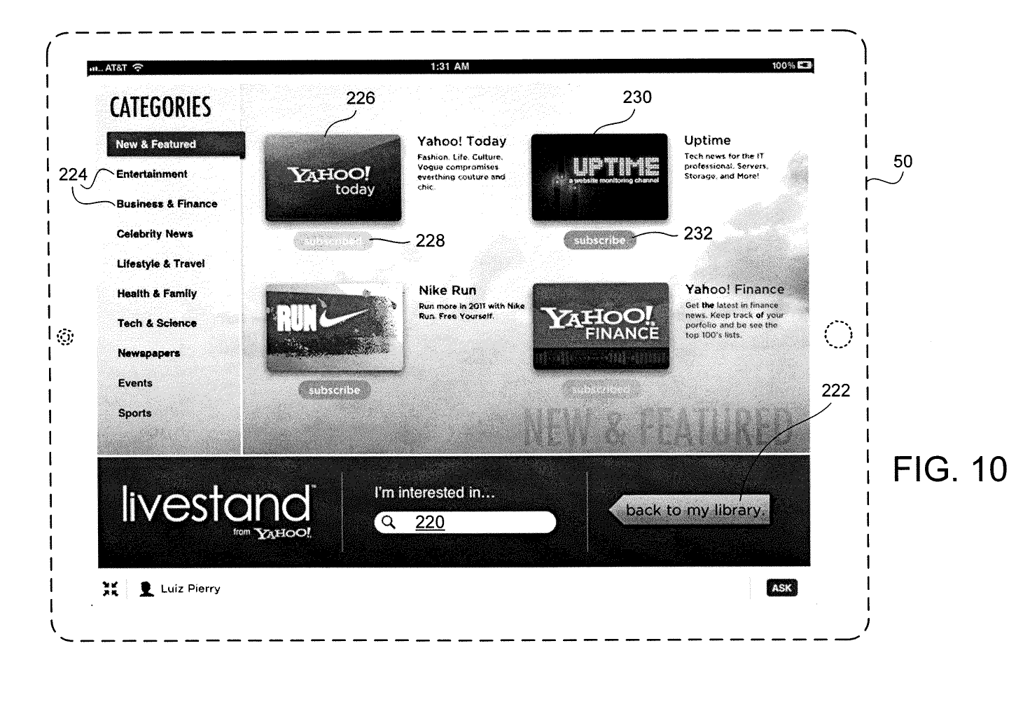

FIG. 10 illustrates a category view of an online publication stand rendered on a tablet computer 50, in accordance with an embodiment of the invention. A search box 220 is provided for enabling the user to search for electronic publications, and a library button 222 is provided to enable the user to navigate to their library of publications. Various categories 224 of electronic publications are provided for the user to select and thereby access different types of publications. In the illustrated embodiment, the “New & Featured” category has been selected, and corresponding publications from the category are shown for selection. The publication 226 is shown with a button 228 indicating that the user is already subscribed to this publication. Whereas for publication 230, the button 232 can be selected by the user in order to subscribe to the publication 230.

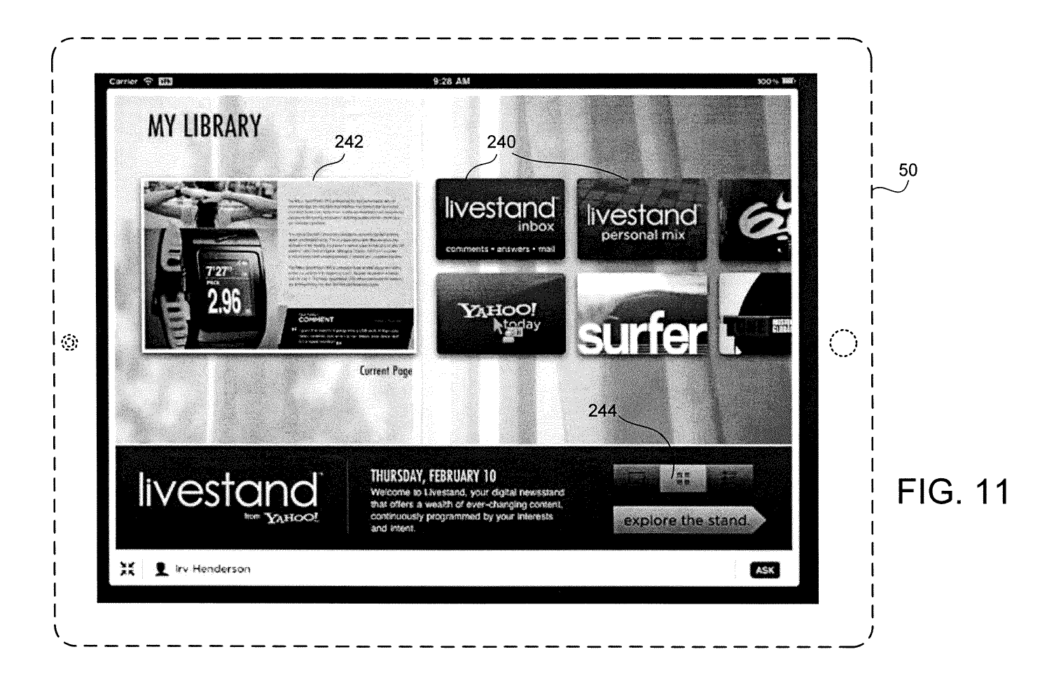

FIG. 11 illustrates a user's library view of an online publication stand, in accordance with an embodiment of the invention. The view of the user's library displays various publications 240 to which the user subscribes. Also, the view includes a current page 242 of a particular publication which the user last engaged with. A view toggle feature 244 enables the user to toggle between various levels of viewing from a single page view within a particular publication to a thumbnail view of the publications in the user's library.

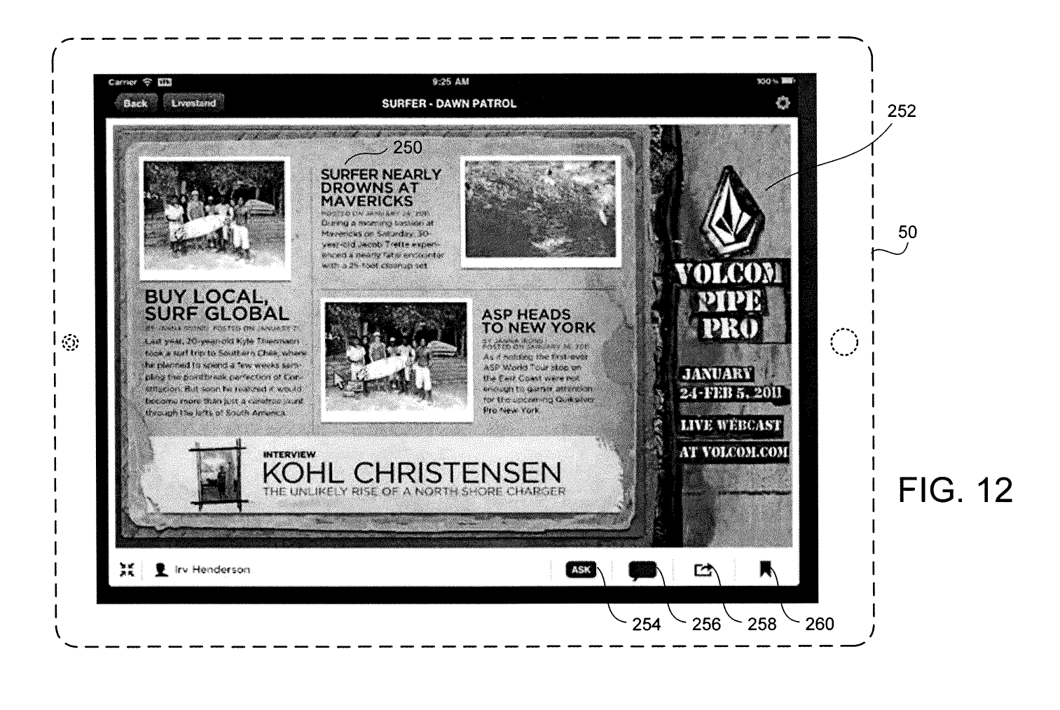

FIG. 12 illustrates a view of a page from an electronic publication, in accordance with an embodiment of the invention. As shown, the page includes vignettes 250 of articles included in the publication. Additionally, a display advertisement 252 is shown on the page. Several options buttons are shown at the bottom of the page. An ask button 254 provides access to help options, such as a help search function or a help menu. A comment button 256 enables the user to access and post comments relating to the electronic publication or to specific articles. A share button 258 enables the user to share the page or an article via e-mail, on a social network, etc. And a bookmark button 260 enables the user to bookmark pages within the electronic publication.

Upon reading the present disclosure, those skilled in the art will realize numerous embodiments within the spirit and scope of the invention. Thus, the following listing of specific embodiments should be considered exemplary and not limiting.

A1. A method for syndicating an electronic publication, comprising:

defining a content pool having a plurality of content pieces;

receiving a selection of content pieces of the content pool from a curator, the selection of content pieces defining a content package;

defining an electronic publication to present the content package;

transmitting the electronic publication for viewing on a presentation device;

tracking interactions with the electronic publication when presented on the presentation device;

determining a revenue amount for the curator based on the tracked interactions with the electronic publication.

A2. The method of embodiment A1,

wherein defining the electronic publication includes defining a display advertisement location within the electronic publication;

wherein transmitting the electronic publication includes retrieving a display advertisement to be presented at the display advertisement location;

wherein tracking interactions with the electronic publication includes tracking interactions with the display advertisement.

A3. The method of embodiment A2,

wherein retrieving the display advertisement includes selecting the display advertisement from a display advertisement pool based on one or more of user data of a user to whom the electronic publication is presented or the tracked interactions with the electronic publication.

A4. The method of embodiment A3,
wherein the user data includes one or more of age, gender, and geographic location.

A5. The method of embodiment A1,

wherein defining the content pool includes receiving the plurality of content pieces from a plurality of authors.

A6. The method of embodiment A5,

wherein tracking interactions with the electronic publication includes tracking interactions with a specific content piece included in the electronic publication.

A7. The method of embodiment A6, further comprising,

determining a revenue amount for a corresponding author of the specific content piece based on the tracked interactions with the specific content piece.

A8. The method of embodiment A6, further comprising,

determining a rating level of a corresponding author of the specific content piece based on the tracked interactions with the specific content piece.

A9. The method of embodiment A1, further comprising,

presenting the content pieces of the content pool for selection by the curator.

A10. The method of embodiment A9,

wherein presenting the content pieces of the content pool includes providing a search tool for searching the content pieces of the content pool.

A11. A system for syndicating an electronic publication, comprising:

a content pool having a plurality of content pieces;

a selection tool for receiving a selection of content pieces of the content pool from a curator, the selection of content pieces defining a content package;

an online publication stand including an electronic publication defined to present the content package, the online publication stand configured to transmit the electronic publication for viewing on a presentation device;

a tracking module for tracking interactions with the electronic publication when presented on the presentation device;

a revenue analyzer configured to determine a revenue amount for the curator based on the tracked interactions with the electronic publication.

A12. The system of embodiment A11,

wherein the electronic publication includes a display advertisement location defined within the electronic publication;

wherein transmitting the electronic publication includes retrieving a display advertisement to be presented at the display advertisement location;

wherein tracking interactions with the electronic publication includes tracking interactions with the display advertisement.

A13. The system of embodiment A12,

wherein retrieving the display advertisement includes selecting the display advertisement from a display advertisement pool based on one or more of user data of a user to whom the electronic publication is presented or the tracked interactions with the electronic publication.

A14. The system of embodiment A13,

wherein the user data includes one or more of age, gender, and geographic location.

A15. The system of embodiment A11, further comprising,

a content pool interface for receiving the plurality of content pieces from a plurality of authors.

A16. The system of embodiment A15,

wherein tracking interactions with the electronic publication includes tracking interactions with a specific content piece included in the electronic publication.

A17. The system of embodiment A16,

wherein the revenue analyzer determines a revenue amount for a corresponding author of the specific content piece based on the tracked interactions with the specific content piece.

A18. The system of embodiment A16, further comprising,

a ratings analyzer for determining a rating level of a corresponding author of the specific content piece based on the tracked interactions with the specific content piece.

A19. The system of embodiment A11,

wherein the selection tool presents the content pieces of the content pool for selection by the curator.

A20. The system of embodiment A19,

wherein the selection tool includes a search tool for searching the content pieces of the content pool.

B1. A method for syndicating an electronic publication, comprising:

defining an advertorial pool having a plurality of advertorials provided by a plurality of advertisers;

receiving a selection of an advertorial of the advertorial pool from a curator;

defining a content package including the selected advertorial;

defining an electronic publication to present the content package;

transmitting the electronic publication for viewing on a presentation device;

tracking interactions with the selected advertorial when presented on the presentation device as part of the electronic publication;

determining an amount to be paid by a corresponding advertiser of the selected advertorial based on the tracked interactions;

determining a revenue amount for the curator based on the tracked interactions.

B2. The method of embodiment B1,

wherein the selected advertorial defines a target audience and an associated monetization value for presentation of the selected advertorial to the target audience;

wherein tracking interactions with the selected advertorial includes determining whether the selected advertorial is presented to its defined target audience;

wherein determining the amount to be paid by the corresponding advertiser of the selected advertorial is based on the selected advertorial's associated monetization value and whether the selected advertorial is presented to its defined target audience.

B3. The method of embodiment B1,

wherein the selected advertorial defines a cost-per-click for an item in the selected advertorial;

wherein tracking interactions with the selected advertorial includes determining whether the item in the selected advertorial is clicked on;

wherein determining the amount to be paid by the corresponding advertiser of the selected advertorial is based on whether the item in the selected advertorial is clicked on and the cost-per-click.

B4. The method of embodiment B1,

wherein the selected advertorial defines a cost-per-conversion;

wherein tracking interactions with the selected advertorial includes determining whether a conversion has occurred via the selected advertorial;

wherein determining the amount to be paid by the corresponding advertiser of the selected advertorial is based on whether a conversion has occurred via the selected advertorial and the cost-per-conversion.

B5. The method of embodiment B1,

wherein the content package includes a non-advertorial content piece.

B6. The method of embodiment B5, further comprising,

determining a revenue amount for an author of the non-advertorial content piece based on the tracked interactions.

B7. The method of embodiment B1, further comprising,

reporting the tracked interactions to the corresponding advertiser.

B8. A method for syndicating an electronic publication, comprising:

defining an advertorial pool having a plurality of advertorials provided by a plurality of advertisers;

receiving a selection of advertorials of the advertorial pool from a curator;

defining a content package including one of the selected advertorials;

determining the one of the selected advertorials included in the content package based on user data of a user;

defining an electronic publication to present the content package;

transmitting the electronic publication for viewing on a presentation device by the user;

tracking interactions with the one of the selected advertorials when presented on the presentation device as part of the electronic publication;

determining an amount to be paid by a corresponding advertiser of the one of the selected advertorials based on the tracked interactions;

determining a revenue amount for the curator based on the tracked interactions.

B9. The method of embodiment B8,

wherein user data includes one or more of age, gender, and geographic location.

B10. The method of embodiment B8,

wherein the content package includes a non-advertorial content piece.

B11. A system for syndicating an electronic publication, comprising:

an advertorial pool having a plurality of advertorials provided by a plurality of advertisers;

a selection tool for receiving a selection of an advertorial of the advertorial pool from a curator, the selected advertorial being included in a content package;

an online publication stand including an electronic publication defined to present the content package, the online publication stand configured to transmit the electronic publication for viewing on a presentation device;

a tracking module for tracking interactions with the selected advertorial when presented on the presentation device as part of the electronic publication;

a revenue analyzer for determining an amount to be paid by a corresponding advertiser of the selected advertorial based on the tracked interactions, and determining a revenue amount for the curator based on the tracked interactions.

B12. The system of embodiment B11,

wherein the selected advertorial defines a target audience and an associated monetization value for presentation of the selected advertorial to the target audience;

wherein the tracking module determines whether the selected advertorial is presented to its defined target audience;

wherein the revenue analyzer determines the amount to be paid by the corresponding advertiser of the selected advertorial based on the selected advertorial's associated monetization value and whether the selected advertorial is presented to its defined target audience.

B13. The system of embodiment B11,

wherein the selected advertorial defines a cost-per-click for an item in the selected advertorial;

wherein the tracking module determines whether the item in the selected advertorial is clicked on;

wherein the revenue analyzer determines the amount to be paid by the corresponding advertiser of the selected advertorial based on whether the item in the selected advertorial is clicked on and the cost-per-click.

B14. The system of embodiment B11,

wherein the selected advertorial defines a cost-per-conversion;

wherein the tracking module determines whether a conversion has occurred via the selected advertorial;

wherein the revenue analyzer determines the amount to be paid by the corresponding advertiser of the selected advertorial based on whether a conversion has occurred via the selected advertorial and the cost-per-conversion.

B15. The system of embodiment B11,

wherein the content package includes a non-advertorial content piece.

B16. The system of embodiment B 15,

wherein the revenue analyzer determines a revenue amount for an author of the non-advertorial content piece based on the tracked interactions.

B17. The system of embodiment B11, further comprising,

a reporting module for reporting the tracked interactions to the corresponding advertiser.

C1. A method for determining revenue of an advertorial in an electronic publication, comprising:

defining an electronic publication to include an advertorial;

transmitting the electronic publication for viewing by a reader on a presentation device;

detecting interactions with the advertorial when presented on the presentation device as part of the electronic publication;

determining an engagement value for the reader based on the detected interactions;

repeating the transmitting, the detecting, and the determining of the engagement value for a plurality of readers;

determining an amount to be paid by a corresponding advertiser of the advertorial based on the engagement values of the plurality of readers.

C2. The method of embodiment C1,

wherein the interactions include one or more of the following: time spent on the advertorial, time spent on a page of the advertorial, selection of a link in the advertorial, a zoom interaction, a resize interaction, a scroll, a refresh, an amount of an audio stream consumed, an amount of a video stream consumed.

C3. The method of embodiment C1, further comprising,

determining a reader value for each of the plurality of readers, the reader value indicating similarity of the reader to a target demographic of the advertorial;

wherein determining the amount to be paid by the corresponding advertiser of the advertorial is based on the reader values of the plurality of readers.

C4. The method of embodiment C3,

wherein the target demographic is defined by one or more of age, gender, geographic location, and interests.

C5. The method of embodiment C3,

wherein determining the reader value includes retrieving reader data of each of the plurality of readers and comparing the retrieved reader data to the target demographic of the advertorial.

C6. The method of embodiment C3,

wherein the reader value is a binary quantity.

C7. The method of embodiment C3,

wherein determining the amount to be paid by the corresponding advertiser of the advertorial includes determining an overall value for each of the plurality of readers based on the reader's engagement value and reader value.

C8. The method of embodiment C1,

wherein determining the engagement value is based on a mapping of combinations of interactions to predefined engagement values.

C9. A system for determining revenue of an advertorial in an electronic publication, comprising:

an online publication stand including an electronic publication defined to include an advertorial, the online publication stand configured to transmit the electronic publication for viewing by a plurality of readers on a plurality of presentation devices;

a tracking module for detecting interactions with the advertorial when presented on the presentation devices as part of the electronic publication;

a revenue analyzer configured to determine engagement values for each of the plurality of readers based on the detected interactions, and determine an amount to be paid by a corresponding advertiser of the advertorial based on the engagement values of the plurality of readers.

C10. The system of embodiment C9,

wherein the interactions include one or more of the following: time spent on the advertorial, time spent on a page of the advertorial, selection of a link in the advertorial, a zoom interaction, a resize interaction, a scroll, a refresh, an amount of an audio stream consumed, an amount of a video stream consumed.

C11. The system of embodiment C9,

wherein the revenue analyzer is configured to determine a reader value for each of the plurality of readers, the reader value indicating similarity of the reader to a target demographic of the advertorial; and

wherein the revenue analyzer determines the amount to be paid by the corresponding advertiser of the advertorial based on the reader values of the plurality of readers.

C12. The system of embodiment C11,

wherein the target demographic is defined by one or more of age, gender, and geographic location.

C13. The system of embodiment C11,

wherein the revenue analyzer determines the reader value by retrieving reader data of each of the plurality of readers and comparing the retrieved reader data to the target demographic of the advertorial.

C14. The system of embodiment C11,

wherein the reader value is a binary quantity.

C15. The system of embodiment C11,

wherein the revenue analyzer determines the amount to be paid by the corresponding advertiser of the advertorial by determining an overall value for each of the plurality of readers based on the reader's engagement value and reader value.

C16. The system of embodiment C9,

wherein the revenue analyzer determines the engagement value based on a mapping of combinations of interactions to predefined engagement values.

Embodiments of the invention herein described may utilize relational database systems as are known in the art. Examples of such database systems include MySQL, Oracle, and Access. Various operations as described above may be effected by performance of an operation via a relational database management system. Such database systems may be embodied in one or more server computers, which may be configured as part of a network of computers.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, and other optical and non-optical data storage devices. The computer readable medium can also be distributed over a network coupled computer systems so that the computer readable code may be stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overall operations are performed in the desired way.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for syndicating an electronic publication, comprising:
defining a content pool having a plurality of content pieces;
receiving a selection of content pieces of the content pool from a curator, the selection of content pieces defining a content package;
defining an electronic publication to present the content package;
transmitting the electronic publication for viewing on a presentation device;
tracking interactions with the electronic publication when presented on the presentation device;
determining a revenue amount for the curator based on the tracked interactions with the electronic publication.

2. The method of claim 1,
wherein defining the electronic publication includes defining a display advertisement location within the electronic publication;
wherein transmitting the electronic publication includes retrieving a display advertisement to be presented at the display advertisement location;
wherein tracking interactions with the electronic publication includes tracking interactions with the display advertisement.

3. The method of claim 2,
wherein retrieving the display advertisement includes selecting the display advertisement from a display advertisement pool based on one or more of user data of a user to whom the electronic publication is presented or the tracked interactions with the electronic publication.

4. The method of claim 3,
wherein the user data includes one or more of age, gender, geographic location, and interests.

5. The method of claim 1,
wherein defining the content pool includes receiving the plurality of content pieces from a plurality of authors.

6. The method of claim 5,
wherein tracking interactions with the electronic publication includes tracking interactions with a specific content piece included in the electronic publication.

7. The method of claim 6, further comprising,
determining a revenue amount for a corresponding author of the specific content piece based on the tracked interactions with the specific content piece.

8. The method of claim 6, further comprising,
determining a rating level of a corresponding author of the specific content piece based on the tracked interactions with the specific content piece.

9. The method of claim 1, further comprising,
presenting the content pieces of the content pool for selection by the curator.

10. The method of claim 9,
wherein presenting the content pieces of the content pool includes providing a search tool for searching the content pieces of the content pool.

11. A method for syndicating an electronic publication, comprising:
defining an advertorial pool having a plurality of advertorials provided by a plurality of advertisers;
receiving a selection of an advertorial of the advertorial pool from a curator;
defining a content package including the selected advertorial;
defining an electronic publication to present the content package;
transmitting the electronic publication for viewing on a presentation device;
tracking interactions with the selected advertorial when presented on the presentation device as part of the electronic publication;
determining an amount to be paid by a corresponding advertiser of the selected advertorial based on the tracked interactions;
determining a revenue amount for the curator based on the tracked interactions.

12. The method of claim 11,
wherein the selected advertorial defines a target audience and an associated monetization value for presentation of the selected advertorial to the target audience;
wherein tracking interactions with the selected advertorial includes determining whether the selected advertorial is presented to its defined target audience;
wherein determining the amount to be paid by the corresponding advertiser of the selected advertorial is based on the selected advertorial's associated monetization value and whether the selected advertorial is presented to its defined target audience.

13. The method of claim 11,
wherein the selected advertorial defines a cost-per-click for an item in the selected advertorial;
wherein tracking interactions with the selected advertorial includes determining whether the item in the selected advertorial is clicked on;
wherein determining the amount to be paid by the corresponding advertiser of the selected advertorial is based on whether the item in the selected advertorial is clicked on and the cost-per-click.

14. The method of claim 11,
wherein the selected advertorial defines a cost-per-conversion;
wherein tracking interactions with the selected advertorial includes determining whether a conversion has occurred via the selected advertorial;
wherein determining the amount to be paid by the corresponding advertiser of the selected advertorial is based on whether a conversion has occurred via the selected advertorial and the cost-per-conversion.

15. The method of claim 11,
wherein the content package includes a non-advertorial content piece.

16. The method of claim 15, further comprising,
determining a revenue amount for an author of the non-advertorial content piece based on the tracked interactions.

17. The method of claim 11, further comprising,
reporting the tracked interactions to the corresponding advertiser.

18. A method for determining revenue of an advertorial in an electronic publication, comprising:
defining an electronic publication to include an advertorial;
transmitting the electronic publication for viewing by a reader on a presentation device;
detecting interactions with the advertorial when presented on the presentation device as part of the electronic publication;
determining an engagement value for the reader based on the detected interactions;
repeating the transmitting, the detecting, and the determining of the engagement value for a plurality of readers;
determining an amount to be paid by a corresponding advertiser of the advertorial based on the engagement values of the plurality of readers.

19. The method of claim 18,
wherein the interactions include one or more of the following: time spent on the advertorial, time spent on a page of the advertorial, selection of a link in the advertorial, a zoom interaction, a resize interaction, a scroll, a refresh, an amount of an audio stream consumed, an amount of a video stream consumed.

20. The method of claim 18, further comprising,
determining a reader value for each of the plurality of readers, the reader value indicating similarity of the reader to a target demographic of the advertorial;
wherein determining the amount to be paid by the corresponding advertiser of the advertorial is based on the reader values of the plurality of readers.

21. The method of claim 20,
wherein the target demographic is defined by one or more of age, gender, geographic location, and interests.

22. The method of claim 20,
wherein determining the reader value includes retrieving reader data of each of the plurality of readers and comparing the retrieved reader data to the target demographic of the advertorial.

23. The method of claim 20,
wherein the reader value is a binary quantity.

24. The method of claim 20,
wherein determining the amount to be paid by the corresponding advertiser of the advertorial includes determining an overall value for each of the plurality of readers based on the reader's engagement value and reader value.

25. The method of claim 18,
wherein determining the engagement value is based on a mapping of combinations of interactions to predefined engagement values.
